(19) United States
(12) Patent Application Publication
(10) Pub. No.: US 2013/0084742 A1
(43) Pub. Date: Apr. 4, 2013

(54) VIDEO GRAPHICS ARRAY CONNECTOR

(71) Applicant: JUN-WEI WANG, Shenzhen City (CN)

(72) Inventor: JUN-WEI WANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/418,362

(22) Filed: Mar. 13, 2012

(30) Foreign Application Priority Data
Sep. 29, 2011 (CN) 201110291785.9

(51) Int. Cl. H01R 13/648; H01R 13/66

(52) U.S. Cl. 439/607.28; 439/620.01; 439/620.05; 439/620.24

(57) ABSTRACT

An exemplary VGA connector includes a number of power pins, a number of signal pins, a number of ground pins, a number of EMI suppression members, and a cable. The power pins are to receive power. The signal pins are to transmit signals. The EMI suppression members are configured to suppress electromagnetic interference. The cable includes a plurality of wires. Each wire corresponds to one pin. Each EMI suppression member is electrically connected between one of the plurality of signal pins and one of the plurality of wires corresponding to the one of the plurality of signal pins.

### BACKGROUND

1. Technical Field

The present disclosure relates to video graphics array connectors and, particularly, to a video graphics array connector capable of suppressing electromagnetic interference.

2. Description of Related Art

Video graphics array (VGA) connectors are common in electronic devices, such as displays. However, the ambient electromagnetic interference (EMI) may enter into the electronic device through a VGA connector without EMI shielding element during an electromagnetic compatibility test process. Therefore, a new VGA is desired to resolve the above problems.

### BRIEF DESCRIPTION OF THE DRAWINGS

The components of the drawing are not necessarily drawn to scale, the emphasis instead being placed upon clearly illustrating the principles of the present disclosure.

FIG. 1 is an isometric, exploded view of a VGA connector in accordance with an exemplary embodiment.

FIG. 2 is an isometric, assembled view of the VGA connector of the FIG. 1.

FIG. 3 is a planar front view of the VGA connector of the FIG. 1.

FIG. 4 is a schematic diagram showing a number of electromagnetic interference suppression members connected to signal pins and wires of a cable.

### DETAILED DESCRIPTION

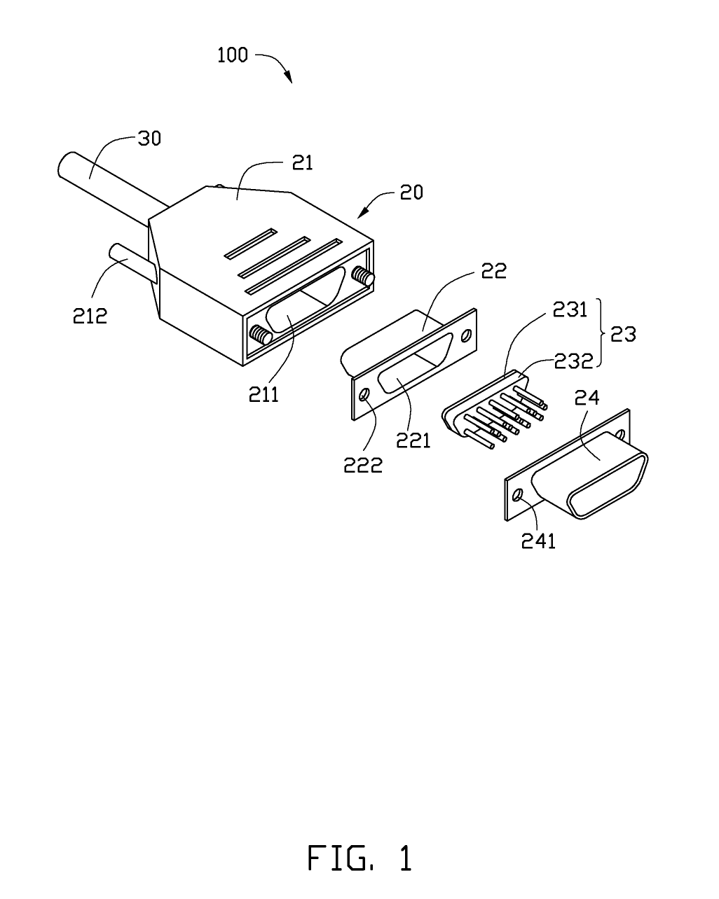

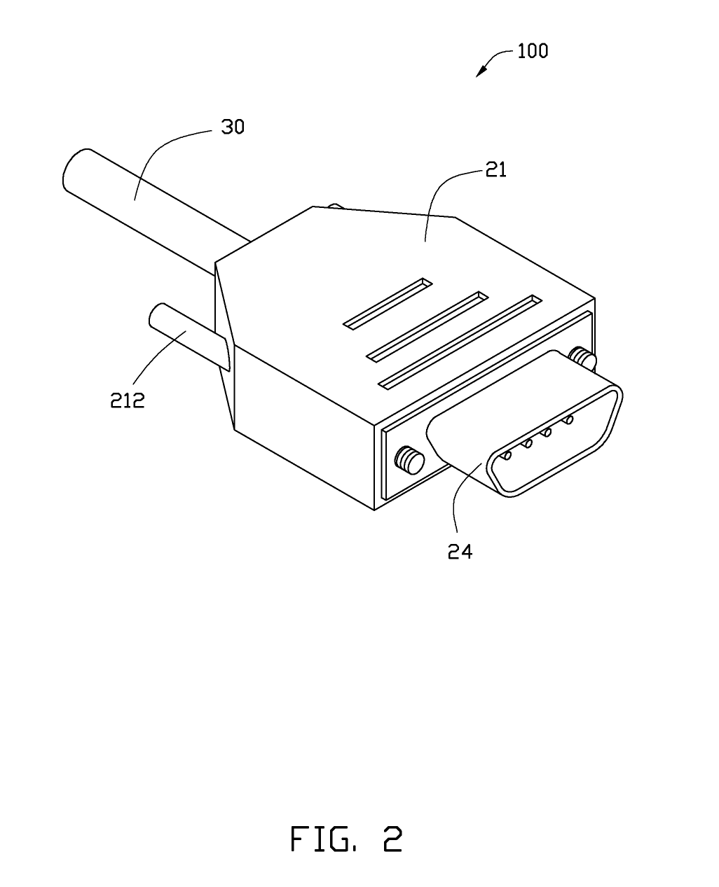

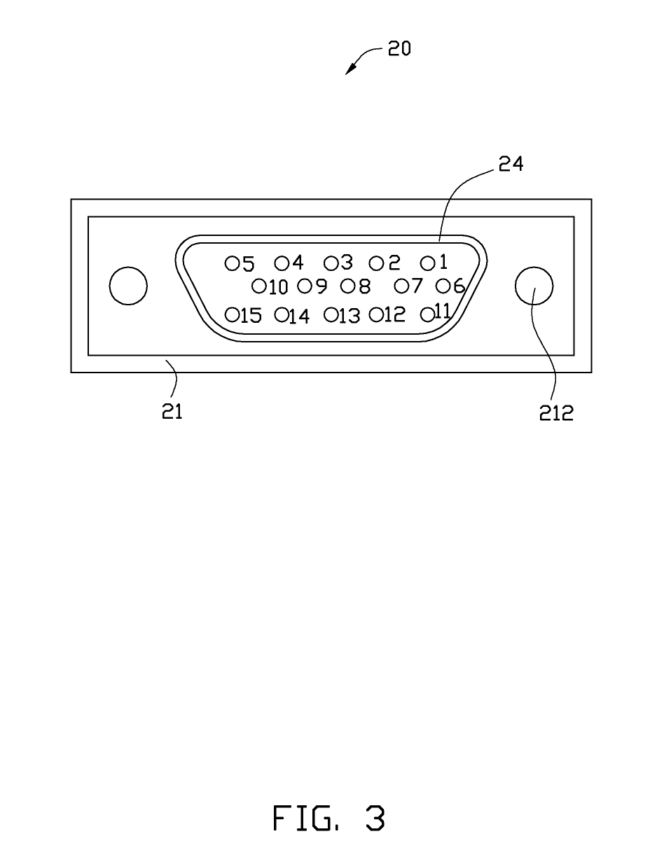

Referring to the FIGS. 1-3, a VGA connector 100 in accordance with an exemplary embodiment is shown. The VGA connector 100 includes at least one male connector 20 and a cable 30. In the embodiment, the number of the male connector is one. The male connector 20 is connected to one end of the cable 30, and another connector (not labeled) is connected to the opposite end of the cable 30.

The male connector 20 includes a housing 21, a face plate 22, and a pin assembly 23. The housing 21 is hollow and defines a first receiving space 211 to receive the face plate 22. The housing 21 further includes at least one fixing screw 212. In the embodiment, the number of the at least one fixing screw is two. Each fixing screw 212 is movably connected to the housing 21 and is arranged beside the first receiving space 211. The fixing screws 212 are used to secure the electrical connection of the VGA connector 100 to an electronic device (not labeled).

The face plate 22 is hollow and defines a second receiving space 221 to receive the pin assembly 23. The face plate 22 further defines at least one first threaded hole 222. The number of the at least one first threaded holes 222 is two. Each first threaded hole 222 is arranged beside the second receiving space 221, and allows the through-presence of one fixing screw 212.

The pin assembly 23 includes a printed circuit board (PCB) 231, a fixing member 232, a number of pins 233, and a number of electromagnetic interference (EMI) suppression members 234. The PCB 231 is received in the second receiving space 221. The fixing member 232 is fixed in the second receiving space 221 by appropriate connection techniques, such as gluing. Each pin 233 extends through the fixing member 232 and is jointed to the PCB 231. In the embodiment, the male connector 20 is a three-row, 15-pin D-Sub connector, and pins 1-5 are arranged from right to left in sequence in a top row, pins 6-10 are arranged from right to left in sequence in a middle row, and pins 11-15 are arranged from right to left in sequence in a bottom row. Pins 1-3 and 11-14 are signal pins to transmit signals, pins 4, 9, and 15 are power pins to receive power from a power supply (not labeled), and pins 5-8, and 10 are grounded. The EMI suppression members 234 are arranged on the PCB 231.

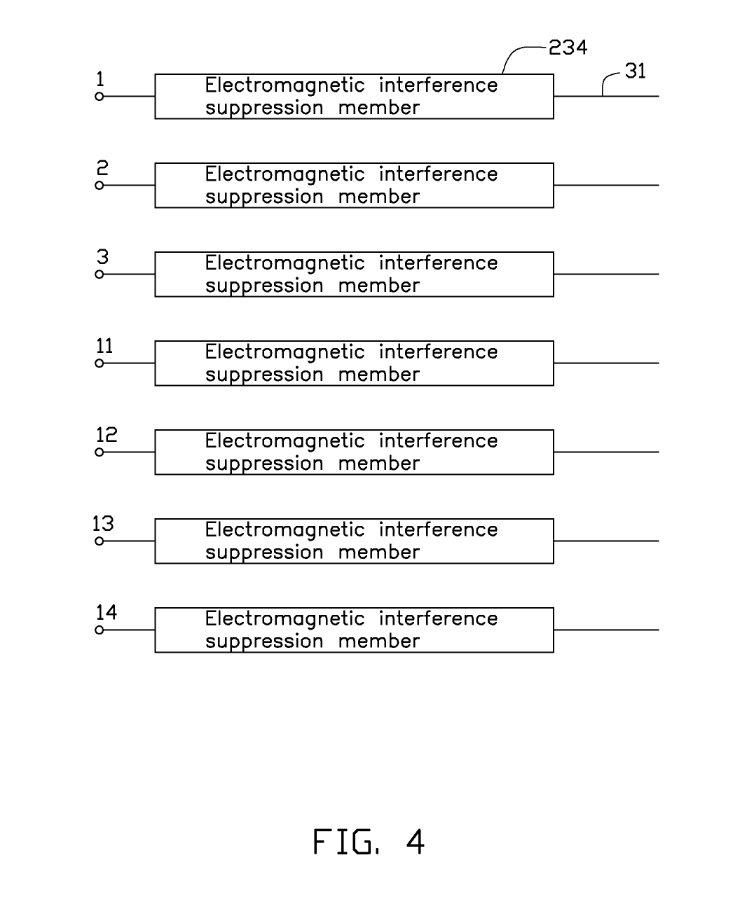

Cable 30 includes a number of wires 31. Each wire 31 corresponds to one pin 233. Each wire 31 is electrically connected to the corresponding pin 233 through the PCB 231. Each wire 31 is to electrically connect the pins 233 of one male connector 20 to the corresponding pins of other connector (not labeled). That is, pins 1-15 of the male connector 20 at one end of the cable 30 are respectively connected to the pins of other connector (not labeled)at the other end of the cable 30 by the wires 31. One EMI suppression member 234 is arranged between one signal pin 233 and its corresponding wire 31, and is used to suppress any EMI in the VGA connector 100 (see FIG. 4). In the embodiment, each EMI suppression member 234 is a ferrite bead. In an alternative embodiment, each EMI suppression member 234 may be a filter.

In the embodiment, each VGA connector 100 further includes a shield 24. The shield 24 is hollow and defines at least one second threaded hole 241 at the opposite side of the shield 24. In the embodiment, the number of the at least one second threaded holes 241 is two. Each second threaded hole 241 corresponds to one fixing screw 212. The second threaded holes 241 engage with and are located by the fixing screws 212. The shield 24 protects the pins 233 from damage.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A video graphics array (VGA) connector comprising:
a plurality of power pins to receive power;
a plurality of signal pins to transmit signals;
a plurality of grounded pins;
a plurality of electromagnetic interference suppression members configured to suppress electromagnetic interference; and
a cable comprising a plurality of wires, each of the plurality of wires corresponding to one of the power pins or the grounded pins;
wherein each of the electromagnetic interference suppression members is electrically connected between one of the plurality of signal pins and one of the plurality of wires corresponding to the one of the plurality of signal pins.

2. The VGA connector as described in claim 1, wherein each of the electromagnetic interference suppression members is Ferrite Bead.

3. The VGA connector as described in claim 1, wherein each of the electromagnetic interference suppression members is a filter.

4. The VGA connector as described in claim 1, wherein the VGA connector comprises a printed circuit board, the electromagnetic interference suppression members are arranged on the printed circuit board, the power pins, the signal pins, and the grounded pins are jointed to the printed circuit board.

5. The VGA connector as described in claim 4, further comprising a housing and a face plate, wherein the housing defines a first receiving space, the face plate defines a second receiving space, the face plate is received in the first receiving space, the printed circuit board is fixed in the second receiving space.

6. The VGA connector as described in claim 5, wherein the housing comprises at least one fixing screw, the at least one fixing screw is movably connected to the housing and arranged beside the first receiving space, the face plate defines at least one first threaded hole, the at least one first threaded hole is beside the second receiving space and corresponding to the at least one fixing screw, to allow the through-presence of at least one fixing screw.

7. The VGA connector as described in claim 6, wherein the VGA connector comprises a shield, the shield is hollow and defines at least one second threaded hole, the at least one second threaded hole is arranged on the opposite side of the shield and corresponding to and is located by the at least one fixing screw.

8. The VGA connector as described in claim 1, wherein the VGA connector is a three-row 15-pin D-Sub connector.
